(19) United States
(12) Patent Application Publication
(10) Pub. No.: US 2017/0367433 A1
(43) Pub. Date: Dec. 28, 2017

(54) WiFi Hard Helmet

(71) Applicant: Noel Frett, Jamaica, NY (US)

(72) Inventor: Noel Frett, Jamaica, NY (US)

(21) Appl. No.: 15/632,368

(22) Filed: Jun. 25, 2017

Related U.S. Application Data
(60) Provisional application No. 62/354,714, filed on Jun. 25, 2016.

(51) Int. Cl. A42B 3/30; A42B 3/04; F21L 4/08; A42B 3/08; A42B 3/12; F21V 23/02; H04W 84/12; F21Y 2115/10

(52) U.S. Cl. CPC A42B 3/30; A42B 3/125; A42B 3/0446; F21V 23/02; F21L 4/08; A42B 3/08; F21Y 2115/10; H04W 84/12

(57) ABSTRACT

Headwear for locating people, such as construction workers, firefighters, mine workers, sandhogs, police officers and military personnel. The headwear is hardhat or helmet that tightly fits on a user's head. The headwear comprised of a LED-light, a built-in WiFi device, and power source. The LED-light provides light to the user. The WiFi device transmits the location of the user.

### CROSS-REFERENCE TO RELATED APPLICATION

The present application is related to and claims priority from prior provisional application Ser. No. 62/354,714, filed Jun. 25, 2017 which application is incorporated herein by reference.

### COPYRIGHT NOTICE

A portion of the disclosure of this patent document contains material which is subject to copyright protection. The copyright owner has no objection to the facsimile reproduction by anyone of the patent document or the patent disclosure, as it appears in the Patent and Trademark Office patent file or records, but otherwise reserves all copyright rights whatsoever. 37 CFR 1.71(d).

### BACKGROUND OF THE INVENTION

The following includes information that may be useful in understanding the present invention(s). It is not an admission that any of the information provided herein is prior art, or material, to the presently described or claimed inventions, or that any publication or document that is specifically or implicitly referenced is prior art.

### 1. FIELD OF THE INVENTION

The present invention relates generally to the field of tracking devices and more specifically relates to a Wi-Fi hard helmet structured and arrange to locate people comprised of a LED-light, a built-in WiFi device to transmit the location of the user, and power source.

### 2. DESCRIPTION OF THE RELATED ART

A tracking system is used for the observing of persons or objects on the move and supplying a timely ordered sequence of respective location data to a model e.g. capable to serve for depicting the motion on a display capability.

Wi-Fi (or WiFi) is a local area wireless computer networking technology that allows electronic devices to connect to the network, mainly using the 2.4 gigahertz (12 cm) UHF and 5 gigahertz (6 cm) SHF ISM radio bands. Many devices can use Wi-Fi, e.g. personal computers, video-game consoles, smartphones, digital cameras, tablet computers and digital audio players. These can connect to a network resource such as the Internet via a wireless network access point. Such an access point (or hotspot) has a range of about 20 meters (66 feet) indoors and a greater range outdoors. Hotspot coverage can be as small as a single room with walls that block radio waves, or as large as many square kilometres achieved by using multiple overlapping access points.

Various attempts have been made to solve problems found in tracking device art. Among these are found in: U.S. Pub. No. 4468656 to Clifford et al; U.S. Pat. No. 8,344,877 to Sheardown et al; and U.S. Publication No. 20120286933 to Vic Hsiao. This prior art is representative of tracking devices.

Ideally, a Wi-Fi hard helmet should be user-friendly and safe in-use and, yet should operate reliably and be manufactured at a modest expense. Thus, a need exists for a Wi-Fi hard helmet structured and arrange to locate people comprised of a LED-light, a built-in WiFi device to transmit the location of the user, and power source and to avoid the above-mentioned problems

### BRIEF SUMMARY OF THE INVENTION

In view of the foregoing disadvantages inherent in the known tracking devices art, the present invention provides a Wi-Fi hard helmet. The general purpose of the present invention, which will be described subsequently in greater detail is to provide a Wi-Fi hard helmet structured and arrange to locate people comprised of a LED-light, a built-in WiFi device to transmit the location of the user, and power source.

A Wi-Fi hard helmet for use by construction workers, firefighters, mine workers, sandhogs, police officers, and military personnel, comprising: a helmet; a Wi-Fi member; a light member; and a power source. The helmet includes a shell member; pad members; and attachment portions. The shell member forms an interior volume adapted to receive a head of a person therein. The pad members are located within the interior volume and are attached to an inner surface of the shell member. The attachment portions are located on opposite side portions of the shell member and are adapted to releasably attach a strap member therebetween for use in securing the Wi-Fi hard helmet to the head of a person. The Wi-Fi member is attached to the shell member and is adapted to send and receive electronic signals. The light member is attached to the shell member and is adapted to shine light from the shell member. The power source is attached to the shell member, is electrically connected to the Wi-Fi member and said light member, and is adapted to provide power to the Wi-Fi member and said light member.

The present invention holds significant improvements and serves as a Wi-Fi hard helmet. For purposes of summarizing the invention, certain aspects, advantages, and novel features of the invention have been described herein. It is to be understood that not necessarily all such advantages may be achieved in accordance with any one particular embodiment of the invention. Thus, the invention may be embodied or carried out in a manner that achieves or optimizes one advantage or group of advantages as taught herein without necessarily achieving other advantages as may be taught or suggested herein. The features of the invention which are believed to be novel are particularly pointed out and distinctly claimed in the concluding portion of the specification. These and other features, aspects, and advantages of the present invention will become better understood with reference to the following drawings and detailed description.

### BRIEF DESCRIPTION OF THE DRAWINGS

The figures which accompany the written portion of this specification illustrate embodiments and method(s) of use for the present invention, Wi-Fi hard helmet, constructed and operative according to the teachings of the present invention.

FIG. 1 shows a perspective view illustrating a Wi-Fi hard helmet in an in-use condition according to an embodiment of the present invention.

FIG. 2 is a perspective view illustrating a Wi-Fi member of the Wi-Fi hard helmet according to an embodiment of the present invention of FIG. 1.

FIG. 3 is a perspective view illustrating pad members of the Wi-Fi hard helmet according to an embodiment of the present invention of FIG. 1.

FIG. 4 is a perspective view illustrating a light member and a power source of the Wi-Fi hard helmet according to an embodiment of the present invention of FIG. 1.

The various embodiments of the present invention will hereinafter be described in conjunction with the appended drawings, wherein like designations denote like elements.

### DETAILED DESCRIPTION

The figures which accompany the written portion of this specification illustrate embodiments and method(s) of use for the present invention, Snow Removal Device, constructed and operative according to the teachings of the present invention.

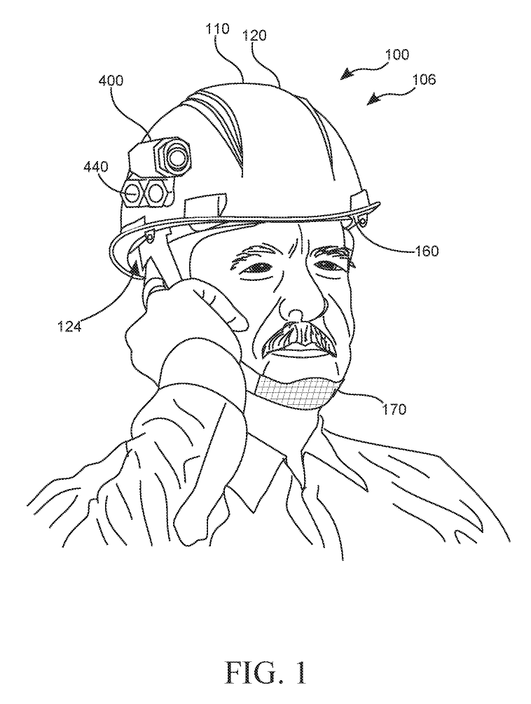

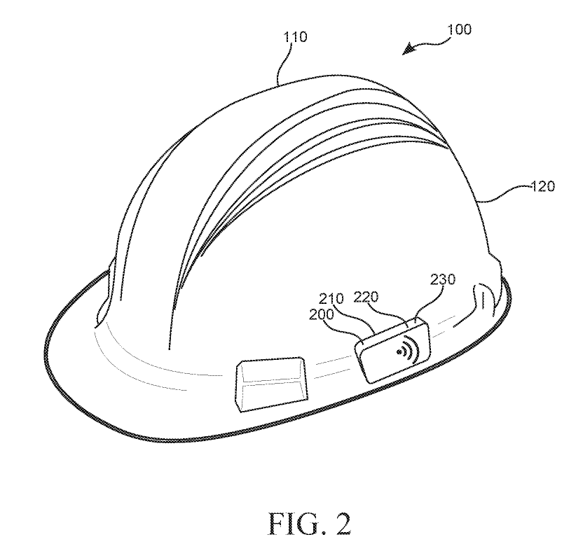

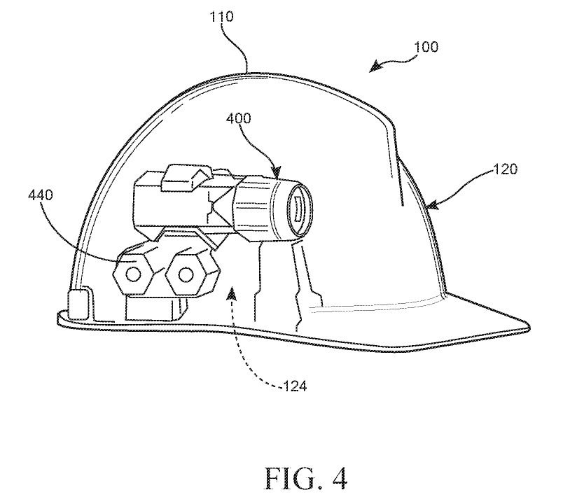

Referring now to FIGS. 1-4, showing perspective views illustrating Wi-Fi hard helmet 100 according to an embodiment of the present invention of FIG. 1.

Wi-Fi hard helmet 100 for use by construction workers, firefighters, mine workers, sandhogs, police officers, and military personnel, comprising: helmet 110; Wi-Fi member 200; light member 400; and power source 440. Helmet 110 includes shell member 120; pad members 300; and attachment portions 160. Shell member 120 forms interior volume 124 adapted to receive a head of a person therein as shown in in-use condition 106 of FIG. 1. Shell member 120 is formed from a material chosen from a group of materials consisting of metal or plastic. Upon reading this specification, it should be appreciated that, under appropriate circumstances, considering such issues as user preferences, design preference, structural requirements, marketing preferences, cost, available materials, technological advances, etc., other material arrangements such as, for example, fiberglass and ceramic, etc., may be sufficient.

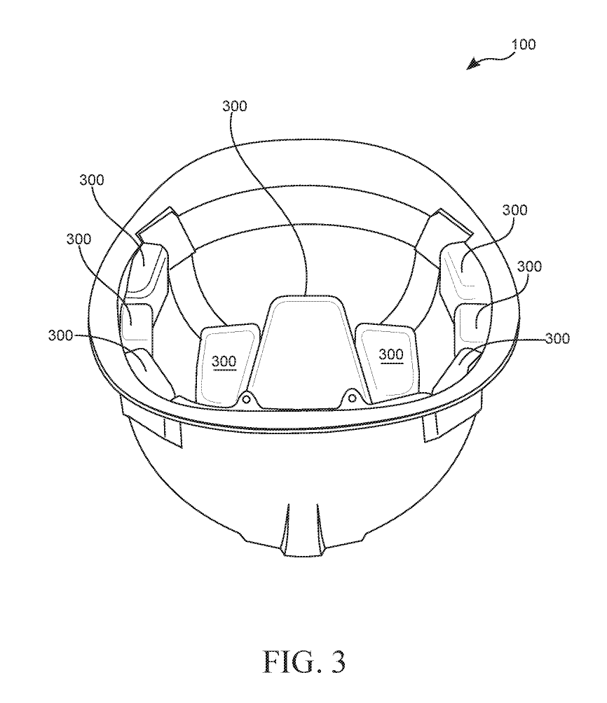

Pad members 300 are located within interior volume 124 and are attached to an inner surface of shell member 120 as shown in FIG. 3. Pad members 300 are located on two opposite side portion and a top portion of the inner surface of shell member 120. Pad members 300 are formed from a material chosen from a group of materials consisting of plastic, cotton, foamed plastic, and cellulose. Wi-Fi hard helmet 100 further comprising chin strap member 170 adapted to releasably connect with attachment portions 160 of shell member 120. Attachment portions 160 are located on opposite side portions of shell member 120 and are adapted to releasably attach strap member therebetween such as chin strap member 170 for use in securing Wi-Fi hard helmet 100 to the head of a person.

Wi-Fi member 200 is attached to shell member 120 and is adapted to send and receive electronic signals. Wi-Fi member 200 is adapted to send information via electronic signals pertaining to the location of Wi-Fi hard helmet 100. WiFi member 200 includes transmitter 210 adapted to send said electronic signals; and receiver 220 adapted to receive electronic signals. WiFi member 200 further includes antenna member 230 for send and receiving electronic signals.

Light member 400 is attached to shell member 120 and is adapted to shine light from shell member 120. Light member 400 is a light emitting diode. Power source 440 is attached to shell member 120, is electrically connected to Wi-Fi member 200 and light member 400, and is adapted to provide power to Wi-Fi member 200 and light member 200. Power source 440 is a battery member. The battery member is rechargeable.

The embodiments of the invention described herein are exemplary and numerous modifications, variations and rearrangements can be readily envisioned to achieve substantially equivalent results, all of which are intended to be embraced within the spirit and scope of the invention. Further, the purpose of the foregoing abstract is to enable the U.S. Patent and Trademark Office and the public generally, and especially the scientist, engineers and practitioners in the art who are not familiar with patent or legal terms or phraseology, to determine quickly from a cursory inspection the nature and essence of the technical disclosure of the application.

What is claimed is new and desired to be protected by Letters Patent is set forth in the appended claims:

1. A Wi-Fi hard helmet for use by construction workers, firefighters, mine workers, sandhogs, police officers, and military personnel, comprising:
a helmet including:
a shell member;
wherein said shell member forms an interior volume adapted to receive a head of a person therein;
pad members;
wherein said pad members are located within said interior volume and are attached to an inner surface of said shell member; and
attachment portions;
wherein said attachment portions are located on opposite side portions of said shell member and are adapted to releasably attach a strap member therebetween for use in securing said Wi-Fi hard helmet to said head of a person;
a Wi-Fi member;
wherein said Wi-Fi member is attached to said shell member and is adapted to send and receive electronic signals;
a light member;
wherein said light member is attached to said shell member and is adapted to shine light from said shell member; and
a power source;
wherein said power source is attached to said shell member, is electrically connected to said Wi-Fi member and said light member, and is adapted to provide power to said Wi-Fi member and said light member.

2. The Wi-Fi hard helmet of claim 1, wherein said Wi-Fi member is adapted to send information via electronic signals pertaining to the location of said Wi-Fi hard helmet.

3. The Wi-Fi hard helmet of claim 1, wherein said light member is a light emitting diode.

4. The Wi-Fi hard helmet of claim 1, wherein said shell member is formed from a material chosen from a group of materials consisting of metal, plastic, fiberglass, and ceramic.

5. The Wi-Fi hard helmet of claim 1, further comprising a chin strap member adapted to releasably connect with said attachment portions of said shell member.

6. The Wi-Fi hard helmet of claim 1, wherein said WiFi member includes a transmitter adapted to send said electronic signals; and a receiver adapted to receive said electronic signals.

7. The Wi-Fi hard helmet of claim 1, wherein said pad members are located on two opposite side portion and a top portion of said inner surface of said shell member.

8. The Wi-Fi hard helmet of claim 1, wherein said pad members are formed from a material chosen from a group of materials consisting of plastic, cotton, foamed plastic, and cellulose.

9. The Wi-Fi hard helmet of claim 1, wherein said power source is a battery member.

10. The Wi-Fi hard helmet of claim 1, wherein said battery member is rechargeable.

11. The Wi-Fi hard helmet of claim 6, wherein said WiFi member further includes an antenna member for send and receiving said electronic signals.
